(19) United States
(12) Patent Application Publication
(10) Pub. No.: US 2002/0091926 A1
(43) Pub. Date: Jul. 11, 2002

(54) Multicast authentication method, multicast authentication server, network interconnection apparatus and multicast authentication system

(75) Inventor: Shoji Fukutomi, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: The Furukawa Electric Co., Ltd., Tokyo (JP)

(21) Appl. No.: 10/020,227

(22) Filed: Dec. 18, 2001

(30) Foreign Application Priority Data
Jan. 10, 2001 (JP) 2001-209929

(51) Int. Cl. H04L 9/00

(52) U.S. Cl. 713/170

(57) ABSTRACT

In response to a participation application from a receiver host, the receiver host capable of participating in a multicast group is registered in a user authentication server in advance, if an IGMP membership report indicating a participation request is transmitted to a router from the receiver host, the receiver host is authenticated based on information in this report and a registration content of the user authentication server, and if the receiver host is authenticated, the receiver host is accepted to participate in the multicast group within accepted time, whereby a user can be accurately authenticated while a function of a receiver-side host remains as it is.

### FIELD OF THE INVENTION

The present invention relates to a multicast authentication method for authenticating the participation of a receiver host in a multicast group of a sender host, an authentication server therefor, a network interconnection apparatus and a multicast authentication system.

### BACKGROUND OF THE INVENTION

The conventional multicast authentication method is standardized by the IETF (Internet Engineering Task Force) As shown in, for example, the block diagram of a multicast authentication system shown in FIG. 25, hosts serving as receivers such as personal computers (to be referred to as “receiver hosts” hereinafter) 10 and 11 are connected to a host serving as a sender (to be referred to as “sender host” hereinafter) 14 in a backbone network 13 delivering a stream of a multicast group through a router 12 serving as a network interconnection apparatus.

In this system, each of the receiver hosts 10 and 11 transmits and receives messages to and from the router 12 according to the IGMP (Internet Group Management Protocol) This IGMP is a standard system in RFC2236. Each of the receiver host 10 and 11 notifies the router 12 of the address of a multicast group which the host is to receive using an IGMP packet. The router 12 forwards a stream of a multicast packet transmitted from the sender host 14 only to ports P0 and P1 receiving such an IGMP, thereby relaying the multicast packet only to the necessary host 10 and 11.

### SUMMARY OF THE INVENTION

According to one aspect of the present invention, there is provided a multicast authentication method for connecting a plurality of receiver hosts and a network of a sender host through a network interconnection apparatus and authenticating participate of the sender host in one multicast group by an authentication server in the network, the method comprising, a registration step of registering an address of each of the receiver hosts in the authentication server in accordance with an application for the participation in the one multicast group of the sender host from each of the receiver hosts, and an authentication step of authenticating each of the receiver hosts based on a registration content of the authentication server in response to a participation request message from the receiver host.

Also, according to another aspect of the present invention, there is provided a multicast authentication method for connecting a plurality of receiver hosts and a network of a sender host through a network interconnection apparatus and a relay unit, and authenticating participate of the sender host in one multicast group by an authentication server in the network, the method comprising, a registration step of registering an address of the relay unit to which the each receiver host is connected in accordance with an application for the participation in the one multicast group of the sender host from each of the receiver hosts, and an authentication step of authenticating the relay unit based on a registration content of the authentication server in response to a participation request message from the receiver host.

Further, according to still another aspect of the present invention, there is provided an authentication server provided in a network of a sender host, comprising a registration unit which registers an address of a receiver host connected to a network of a sender host in accordance with a participation application for participating in a multicast group of the sender host from the receiver host.

Furthermore, according to still another aspect of the present invention, there is provided an authentication server provided in a network of a sender host, comprising a registration unit which registers an address of a receiver host connected to a network of a sender host through a relay unit in accordance with a participation application for participating in a multicast group of the sender host from the receiver host.

Moreover, according to still another aspect of the present invention, there is provided a network interconnection apparatus connected to a plurality of receiver hosts and connected to an authentication server through a network of a sender host, comprising, a transmission processing unit which extracts a transmitting end address of a participation request message received from each of the receiver hosts, for creates a message inquiring about authentication information, and conducts a transmission processing for transmitting the created message to the authentication server, and an acceptance unit which accepts participation of the each receiver host in a multicast group based on an authentication result message received from the authentication server.

Additionally, according to still another aspect of the present invention, there is provided a multicast authentication system comprising, a plurality of receiver hosts, a network of a sender host, a network interconnection apparatus for connecting the plurality of receiver hosts to the network, and an authentication server provided in the network, wherein the authentication server consists of the authentication server stated above, the network interconnection apparatus consists of the network interconnection apparatus stated above, and the authentication server authenticates the participation of the one receiver host in the multicast group of the sender host, and the network interconnection apparatus accepts the receiver host to participate in the multicast group.

Other objects and features of this invention will become understood from the following description with reference to the accompanying drawings.

### BRIEF DESCRIPTION OF THE DRAWINGS

FIG. 1 is a block diagram showing the schematic configuration of a multicast authentication system in the embodiment according to the present invention;

FIG. 2 is a block diagram showing one example of the configuration of a multicast receiver authentication table included in the user authentication server shown in FIG. 1;

FIG. 3 is a time chart showing the operations of the respective constituent elements of the system shown in FIG. 1;

FIG. 4 shows the packet format of an IGMP membership report message;

FIG. 5 shows the format of IGMP Message shown in FIG. 4;

FIG. 6 shows the packet format of a RADIUS message;

FIG. 7 shows the format of RADIUS Message shown in FIG. 6;

FIG. 8 shows the format of Attributes shown in FIG. 7;

FIG. 9 is a block diagram showing the configuration of a multicast authentication system in the first embodiment according to the present invention;

FIG. 10 is a block diagram showing one example of the configuration of a CE router shown in FIG. 9;

FIG. 11 is a block diagram showing one example of the configuration of a PE router shown in FIG. 9;

FIG. 12 is a block diagram showing the configuration of a multicast receiver management table shown in FIG. 11;

FIG. 13 is a block diagram showing the configuration of a multicast forwarding table shown in FIG. 11;

FIG. 14 is a block diagram showing one example of the configuration of a user authentication server shown in FIG. 9;

FIG. 15 is a block diagram showing one example of the configuration of a delivery accept server shown in FIG. 9;

FIG. 16 is a block diagram showing one example of the configuration of a database shown in FIG. 15;

FIG. 17 is a flow chart showing the received packet identification operation of the PE router shown in FIG. 11;

FIG. 18 is a flow chart for explaining the delivery operation of the delivery accept server shown in FIG. 15;

FIG. 19 is a flow chart for explaining the relay operation of the CE router shown in FIG. 10;

FIG. 20 is a flow chart for explaining the control operation of an IGMP control section shown in FIG. 11;

FIG. 21 is a flow chart for explaining the authentication operation of the user authentication server shown in FIG. 14;

FIG. 22 is a flow chart for explaining the authentication operation of an authentication control section shown in FIG. 11;

FIG. 23 is a flow chart for explaining the forwarding processing operation of a multicast forwarding control section shown in FIG. 11;

FIG. 24 is a block diagram showing the configuration of a multicast authentication system in the third embodiment according to the present invention; and

FIG. 25 is a block diagram showing the schematic configuration of a conventional multicast authentication system.

### DETAILED DESCRIPTIONS

The present invention has been achieved in order to solve the following problems.

However, the IGMP employed in the conventional system does not include a user authentication mechanism. For that reason, the router receiving IGMP messages from the receiver hosts 10 and 11 unconditionally forwards the multicast stream from the sender host 14.

This does not arouse any problems if the usage of the system is not limited in, for example, the LAN environment of a company. However, problems occur if paid contents are delivered in the network of the Internet service provider. Namely, if a multicast stream forwarded from the service provider can be received by any receiver who requests the multicast stream, the receivers cannot be disadvantageously, accurately recognized, which is also disadvantageous in view of illegal access and accounting.

Furthermore, Internet Draft “IGMP Extension for Authentication of IP Multicast Sender and Receiver” (drafted by Norihiro Ishikawa), February, 1999 proposed extending the IGMP to authenticate a receiver. This proposal has disadvantages in that the function of a receiver-side host should be also extended and that the existing function thereof cannot be used as it is.

The preferred embodiments of a multicast authentication method, a multicast authentication server, a network interconnection apparatus and a multicast authentication system according to the present invention will be described hereinafter with reference to the accompanying drawings. It is noted that the same or equivalent constituent elements as those shown in FIG. 25 are denoted by the same reference symbols for the sake of description.

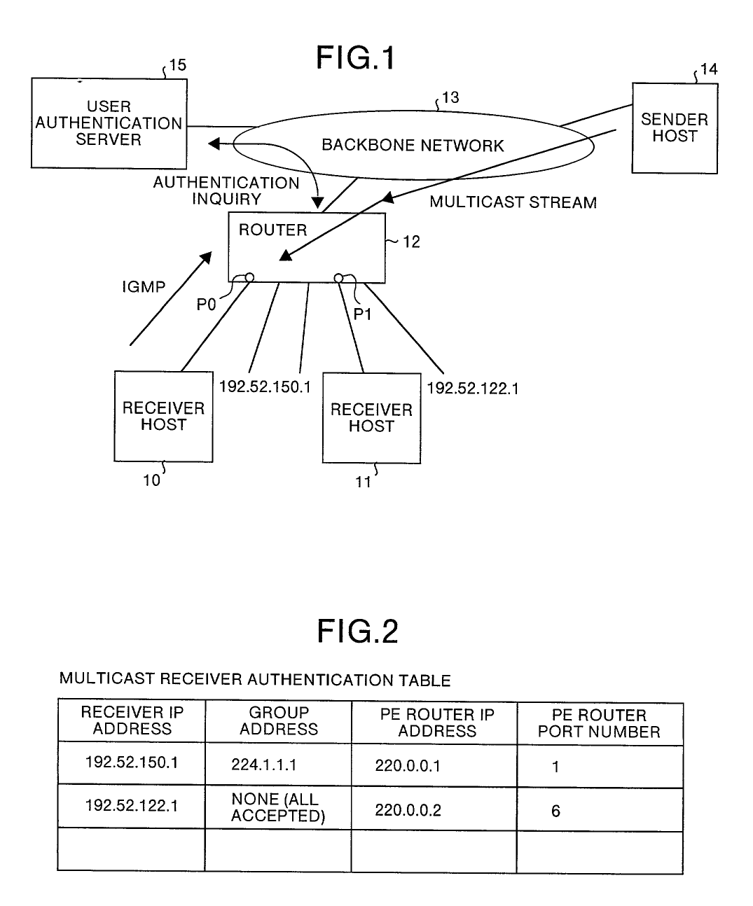

FIG. 1 is a block diagram showing the schematic configuration of a multicast authentication system according to the present invention. The configuration of the system shown in FIG. 1 differs from that of the system shown in FIG. 25 in that a user authentication server 15 is provided in the backbone network 13. With respect to, for example, an application for the delivery plan of a content opened on a Web page in advance, user information (address) input by a user, the group address of a content (multicast group) in which the user wants to participate, information on the ports of a PE router 12 to which receiver hosts 10 and 11 are connected, respectively are registered as database in the user authentication server 15.

If each of the receiver hosts 10 and 11 notifies an application to the effect that the user of the receiver host wants to participate in, for example, a content to be delivered from a sender host 14 with the transmitting end address of the receiver host used as the IP address of the host, the address of the receiver host is registered in the user authentication server 15.

If the receiver host issues a participation request, the user authentication server 15 retrieves a registered address from the transmitting end address in the message of the participation request transmitted through the PE router 12. If the transmitting end address coincides with the registered address, the user authentication server 15 authenticates the receiver host and the receiver host can thereby constantly receive the delivery of the content from the sender host 14.

However, the number of types of contents delivered from the sender host 14 is not limited to one. Actually, a plurality of types of contents exist. For this reason, it is sometimes necessary to authenticate a receiver host for each content. In that case, the receiver host designates the address of a specific multicast group in which the user wants to participate from respective multicast groups to be delivered, whereby the receiver host is registered in the multicast receiver authentication table of the user authentication server 15.

In this case, too, if the receiver host issues a participation request, the user authentication server 15 retrieves a registered address from the transmitting end address and the group address in the message of the above-stated participation request transmitted through the PE router 12. When the transmitting end address coincides with the registered address, the receiver host is authenticated and the receiver host can constantly receive the delivery of the content from the sender host 14.

The receiver host can also issue a participation request without designating the group address of this specific multicast group. In that case, however, all multicast groups are designated and registered in the multicast receiver authentication table of the user authentication server 15.

In this case, if the receiver host issues a participation request, the user authentication server 15 retrieves a registered address from the transmitting end address in the message of the above-stated participation request transmitted through the PE router 12. If the transmitting end address coincides with the registered address, the receiver host is authenticated and the receiver host can constantly receive the delivery of a plurality of contents from the sender host 14.

As for a receiver host which tries participating in a multicast group using an arbitrary IP address which is not the IP address of the receiver host itself, the above-stated authentication cannot prevent illegal participation. Considering this, it is also possible to make authentication based on information on, for example, the port of the PE router 12 to which the receiver host 10 or 11 is connected.

In this case, if the receiver host issues a participation request, the user authentication server 15 retrieves a registered address from information on the transmitting end address and the port in the message of the above-stated participation request transmitted through the PE router 12. If the transmitting end address coincides with the registered address, the receiver host is authenticated and the receiver host can constantly receive the delivery of a plurality of contents from the sender host 14.

It is noted that the port information according to the present invention is not limited to information on a physical port to which the receiver host is actually connected but may be, for example, logical port information. In that case, it is possible to prevent illegal access from physical ports other than the physical port belonging to the logical port.

Some contents are delivered at real time such as the live delivery of, for example, music or the games of sports. In case of such live delivery, it is possible to specify time at which such a live takes place. Therefore, it is possible to register content delivery accepted time corresponding to the above-stated data.

Items used for authentication can be appropriately combined according to utilization conditions. While the authentication is normally conducted by the user authentication server 15, it is also possible to provide the PE router 12 with this authentication function.

FIG. 2 is a block diagram showing the configuration of the multicast receiver authentication table in this user authentication server 15. In FIG. 2, this multicast receiver authentication table stores receiver IP addresses which are the IP addresses of receiver hosts, the group addresses of multicast groups in which the respective receiver hosts participate, the IP addresses of the ports of the PE router 12 to which the respective receiver hosts are connected, and the port numbers of the PE router 12.

This configuration example shows a case where the receiver IP addresses of the receiver hosts 10 and 11 are “192.52.150.1” and “192.52.122.1”, respectively, the group address of the multicast group delivered to the receiver host 10 is “224.1.1.1”, and the receiver host 11 receives the delivery of all the multicast groups. Also, in this configuration example, the PE router IP address of the port of the PE router 12 to which the receiver host 10 is connected is “220.0.0.1”, the port number thereof is “1”, the PE router IP address of the port of the PE router 12 to which the receiver host 11 is connected is “220.0.0.2”, and the port number thereof is “6”.

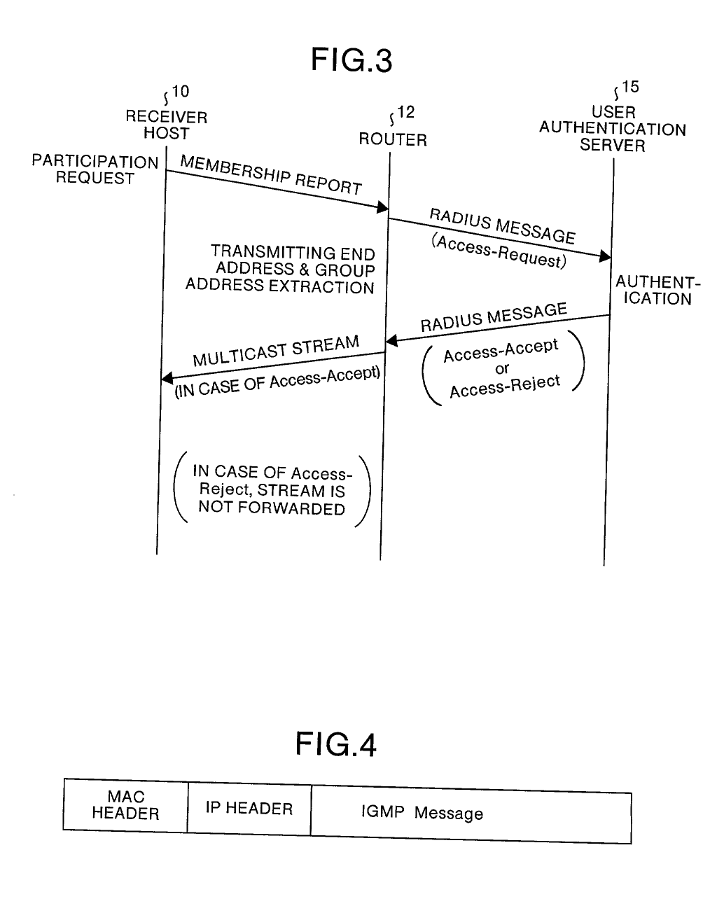

With the above-stated configuration, as shown in a time chart of FIG. 3, each of the receiver hosts 10 and 11 transmits the group address of a multicast group which the receiver host is to receive (note that there is no group address for the receiver address 11) to the router 12 while adding the group address to the message of an IGMP membership report. If receiving this report, the router 12 extracts the transmitting end address of the receiver host and the group address of the multicast group for which the receiver host issues a participation request and inquiries of the user authentication server 15 about the extracted information.

It is noted that this inquiry is made using, for example, a RADIUS message to be described later. At the time of the inquiry, a code indicating the type of the RADIUS message, to be described later, transmits an “Access-Request” message. This message is transmitted to the user authentication server 15 at certain intervals, for example, ten minutes' intervals even after the receiver host is authenticated. This is intended to deal with, for example, a case where a user cancels a reservation and to deal with such cancellation even if delivery is charged.

Even if a delivery reservation is made with delivery time designated, the user may possibly cancel or change the reservation. To deal with the cancellation or change, therefore, it is necessary to regularly transmit the “Access-Request” message from the router 12 to the user authentication server 15, to check the multicast receiver authentication table in the user authentication server 15 and to respond to the message even after the user is authenticated.

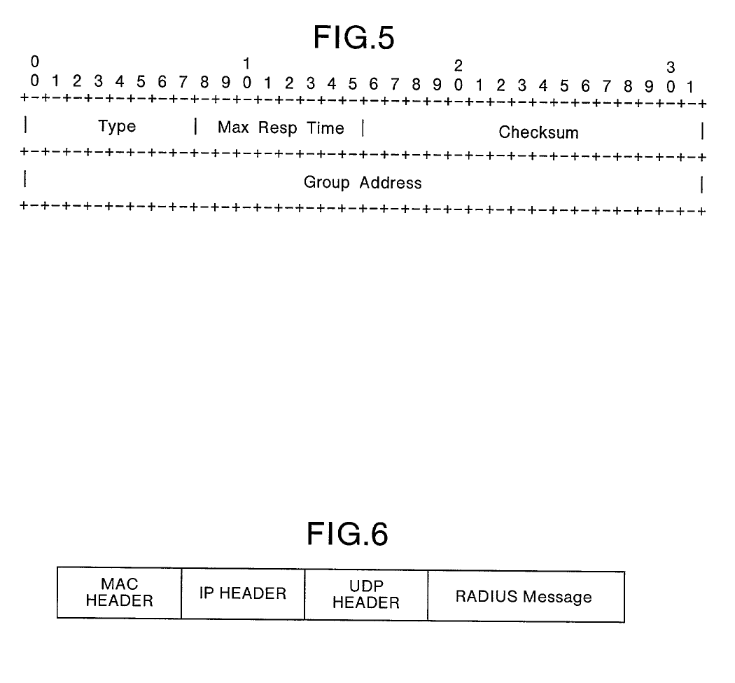

As shown in FIG. 4, the packet format of the IGMP membership report message consists of an MAC header storing a transmitting end address and a destination address at layer 2 level, an IP header storing a transmitting end address and a destination address at layer 3 level, and an IGMP message. As shown in the format of FIG. 5, the IGMP message consists of Type indicating the type of the message, Max Resp Time, Checksum for packet check, and Group Address storing a group IP address.

In this embodiment, Type consists of a value of 0×16 indicating a version 2 membership report, Max Resp Time consists of a value of 0, Checksum consists of a checksum value of the IGMP message (a Checksum part is calculated as 0), and Group Address stores the address of a multicast group (multicast address) in which the receiver host is to participate.

In this embodiment, the transmitting end address of the receiver host in the IP header shown in FIG. 4 and the group address of the multicast group in IGMP message shown in FIG. 5 for which the receiver issues a participation request are extracted, a pair of the transmitting end address and the group address is set as one user name and a RADIUS message to be described next is created.

As shown in FIG. 6, the packet format of this RADIUS message consists of an MAC header storing a transmitting end address and a destination address at layer 2 level, an IP header storing a transmitting end address and a destination address at layer 3 level, a UDP header of a transport layer, and RADIUS message.

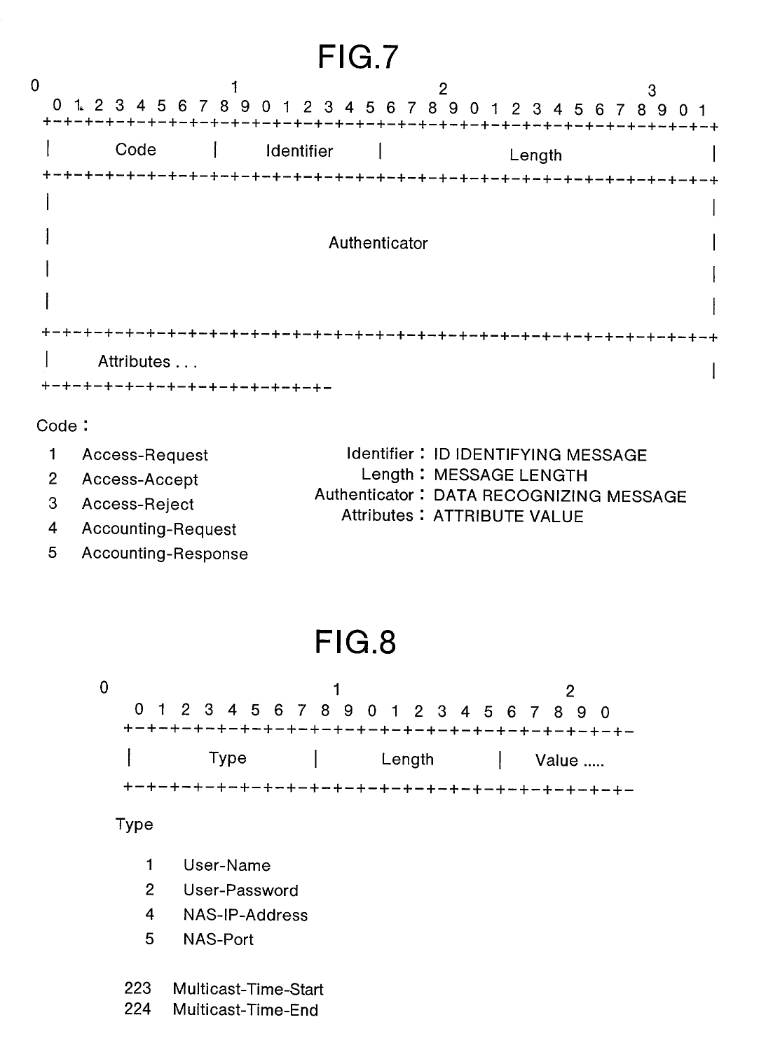

As shown in FIG. 7, this RADIUS Message consists of Code indicating the type of this message, Identifier which is an ID for identifying this message, Length indicating the length of this message, Authenticator which is data (for example, hash of MD5) for authenticating this message and Attributes indicating an attribute value. Also, as shown in FIG. 8, Attributes consists of Type indicating the type of the attribute, length indicating a data length, and Value showing an actual value indicated by this Type.

It is noted that Code of the RADIUS Message shown in FIG. 7 indicates as follows. If Code is 1, the message is an “Access-Request” RADIUS message inquiring of authentication based on the transmitting end address of the receiver host and the group address of the multicast group for which the receiver host issues a participation request. If Code is 2, the message is an “Access-Accept” RADIUS message accepting authentication. If Code is 3, the message is an “Access-Reject” RADIUS message rejecting authentication. If Code is 4, the message is an “Accounting-Request” RADIUS message requesting to count the passage of time. If Code is 5, the message is an “Accounting-Response” RADIUS message responding this count.

As shown in FIG. 8, Type of Attributes shown in FIG. 7 indicates as follows. If Type is 1, the attribute is a user name. At this time, if the IP address of the receiver host 10 is, for example, “192.52.150.1” and the group IP address is “224.1.1.1”, the actual value of “192.52.150.1-224.1.1.1” is stored in value. If Type is 2, the attribute is a user password and the value of, for example, “RADIUS-CLIENT” is stored in Value.

If all the multicast groups are designated, only the value of IP address of the receiver host 11, namely, “192.52.122.1” is stored in Value.

If Type of Attribute is 4, the attribute is NAS-IP-Address and the value of NAS-IP-Address which is the IP address of the port of the PE router, for example, the value “220.0.0.1” of the IP address of the PE router to which the receiver host 10 is connected, is stored in Value. If Type of Attribute is 5, the attribute is NAS-Port and the value of NAS-Port which is the number of the port, for example, “1” is stored in Value.

If information on the receiver host 10 and that on the port are designated, then only the value of the IP address “192.52.150.1” of the receiver host 10 is stored in Value, “220.0.0.1” is stored as the value of NAS-IP-Address and “1” is stored as the value of NAS-Port.

If Type of Attribute is 223, the value of time when a content delivery service is started, namely, “Multicast-Time-Start” is stored in Value. If Type of Attribute is 224, the value of time when a content delivery service is ended, namely, “Multicast-Time-End” is stored in Value.

It is noted that this time information can be designated while combining with each of the above-stated designations to thereby make it possible to authenticate a user within content delivery time.

When receiving this inquiry RADIUS message, the user authentication server 15 checks the IP address of the receiver host from a registration content, determines whether or not the receiver host is authenticated for the participation in the multicast group and transmits this authentication result (and accepted time for participating in the multicast group if accepted time is set) to the router 12. It is noted that this response is made by the above-stated RADIUS message. At the time of the response, the user authentication server 15 transmits the code indicating the type of the RADIUS message, which is “Access-Accept” if authentication is accepted and “Access-Reject” if authentication is not accepted, to the router 12.

If participation accepted time is set and the user authentication server 15 received this inquiry RADIUS message prior to this participation accepted time, then the user authentication server 15 determines that authentication fails even with the inquiry of authentication about the receiver host coincident with the registration content and transmits an “Access-Reject” RADIUS message to the router 12.

If receiving the “Access-Accept” message indicating that the authentication result shows the acceptance of the authentication, the router 12 performs the same processing as that performed when receiving a normal IGMP and forwards a corresponding multicast stream to the port of the interface to which the participation-accepted receiver host is connected (or forwards the corresponding multicast stream within the participation accepted time if the participation accepted time is set). If receiving the “Access-Reject” message indicating that the authentication result shows rejection to authenticate the receiver host, the router 12 judges that no IGMP is received from the receiver host and does not forward the corresponding multicast stream to the interface port.

According to the present invention, a multicast stream is transmitted to the participation-accepted user based on the information in the IGMP membership report and the registration content of the authentication server which content is registered in advance. This makes it possible to accurately authenticate the receiver host while the function of the receiver host remains as it is, to thereby prevent a participation-unaccepted user from receiving this multicast stream and to realize a paid stream delivery service utilizing multicast, accordingly.

According to the present invention, a multicast stream in a predetermined multicast group or in all the multicast groups is transmitted to the user accepted to participate in the predetermined group or all the groups. Due to this, as in the case of the above, it is possible to accurately authenticate the receiver host while the function of the receiver host remains as it is, to thereby prevent a participation-unaccepted user from receiving this multicast stream and to realize a paid stream delivery service utilizing multicast, accordingly.

According to the present invention, a multicast stream in a multicast group is transmitted to the user of the receiver host connected to a predetermined port. Due to this, it is possible to authenticate the receiver host more accurately while the function of the receiver host remains as it is, thereby to prevent a participation-unaccepted user from receiving this multicast stream and to realize a paid stream delivery service utilizing multicast, accordingly.

According to the present invention, multicast group participation accepted time is set as an authentication target and a multicast stream is transmitted to the participation-accepted user within the participation accepted time. This makes it possible to prevent the participation-unaccepted user from receiving this multicast stream and to realize a paid stream deliver service using multicast stream, accordingly.

The embodiments of a multicast authentication system will be explained.

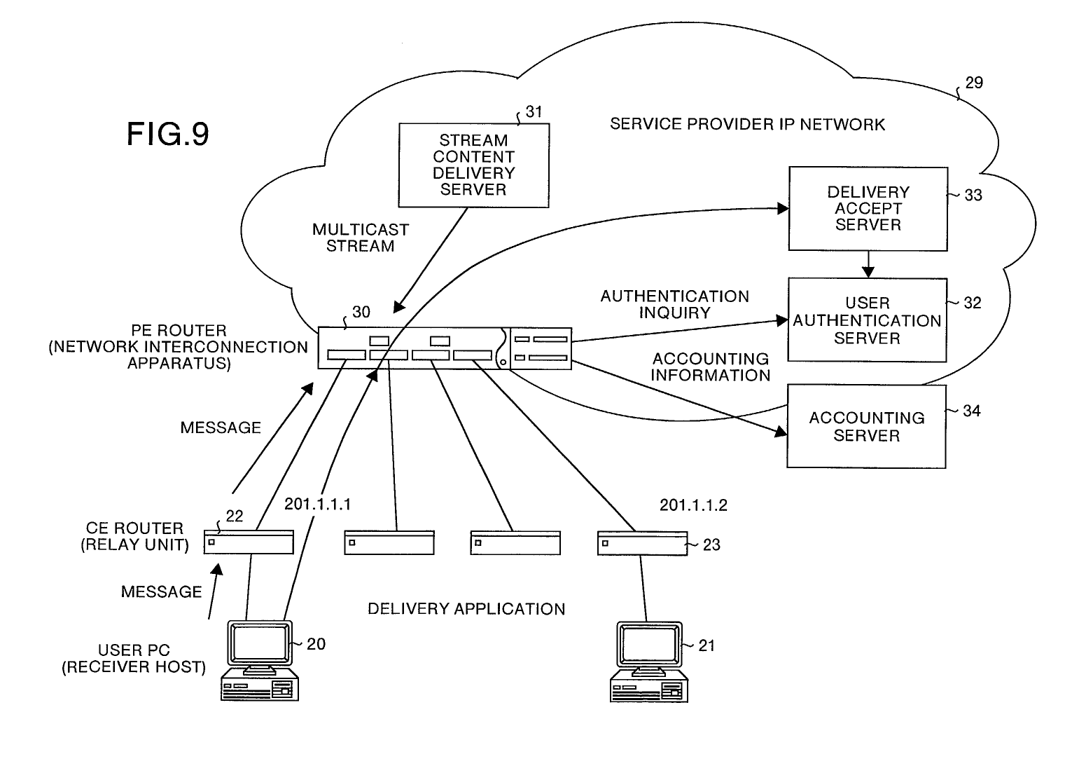

FIG. 9 is a block diagram showing the configuration of a multicast authentication system in the first embodiment according to the present invention. In FIG. 9, this system consists of a plurality of user PC's (receiver hosts) 20 and 21, customer edge routers (to be referred to as “CE routers” hereinafter) 22 and 23 serving as relay units to which the user PC's 20 and 21 are connected, respectively, a provider edge router (to be referred to as “PE router”) 30 serving as a network interconnection apparatus provided in the IP network 29 of a service provider, a stream content delivery server 31 also provided in the IP network 29 and delivering streams, a user authentication server 32 also provided in the IP network 29 and authenticating the user PC's, a delivery accept server 33 also provided in the IP network 29 and accepting delivery from the user PC's, an accounting server 34 provided in the IP network 29 and calculating charged rates.

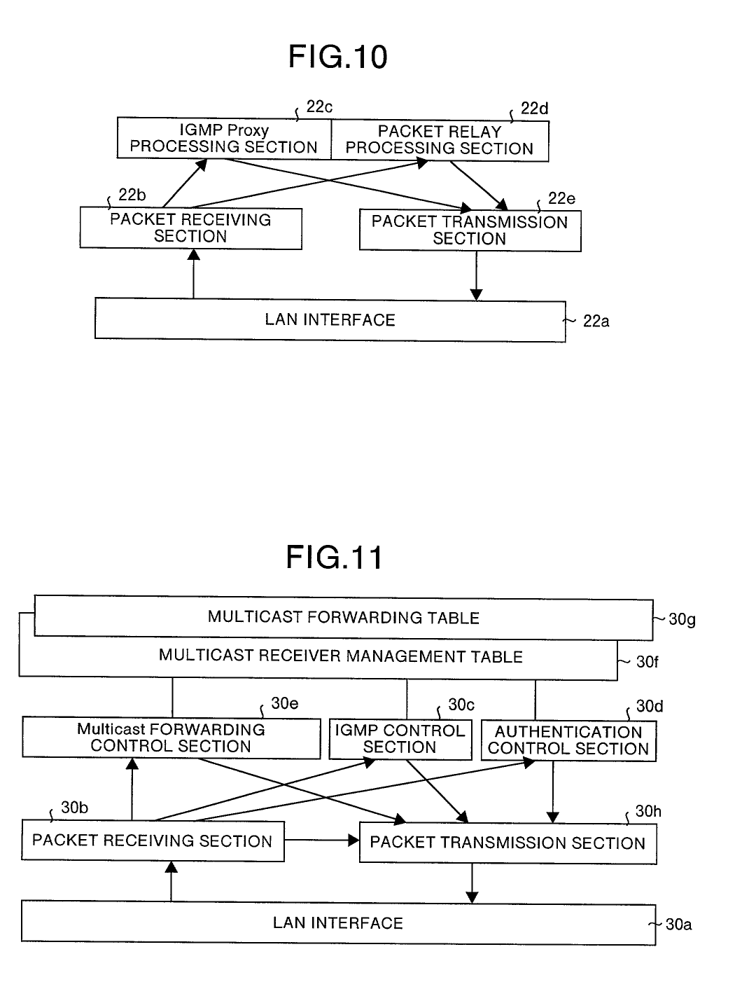

The CE routers 22 and 23 are interposed between the user PC's 20 and 21 and the PE router 30, respectively and relay the message packets of IGMP membership reports from the user PC's 20 and 21 to the PE router 30 and the transmission and receiving of data between the user PC's 20 and 21 and the delivery accept server 33 on Web pages. Since the CE routers 22 and 23 are the same in configuration, FIG. 10 typically shows the configuration of the CE router 22. In FIG. 10, the CE router 22 consists of a LAN interface 22a connected to the user PC 20 and the PE router 30 through ports, a packet receiving section 22b receiving a packet fetched by the LAN interface 22a, discriminating the type of the packet and sorting the packet, an IGMP Proxy processing section 22c processing the message packet of the IGMP membership report sorted by the packet receiving section 22b using the IGMP Proxy function, a packet relay processing section 22d conducting a relay processing to a multicast packet sorted by the packet receiving section 22b, and a packet transmission section 22e transmitting the packet processed by the respective processing sections 22c and 22d. The IGMP Proxy processing section 22c acts as an IGMP Proxy and changes a transmitting end address from the IP address of the user PC 20 to the IP address of the CE router 22 when the packet is relayed from the user PC 20.

As shown in FIG. 11, the PE router 30 consists of a LAN interface 30a connected to the CE routers 22 and 23 and the various servers 31 to 34 through ports, a packet receiving section 30b receiving a packet fetched by the LAN interface 30a, discriminating the type of the packet and sorting the packet, an IGMP control section 30c conducting a control processing to the message packet of an IGMP membership report sorted by the packet receiving section 30b, an authentication control section 30d conducting a control processing to the packet of a RDIUS message sorted by the packet receiving section 30b, a multicast forwarding control section 30e conducting a forwarding control processing to the multicast packet sorted by the packet sorting section 30b, a multicast receiver management table 30f connected to the respective control sections 30c to 30e and storing multicast receiver information obtained from the packets, a multicast forwarding table 30g storing router information for forwarding the multicast packet, and a packet transmission section 30h transmitting the packets processed by the respective control sections 30c to 30e.

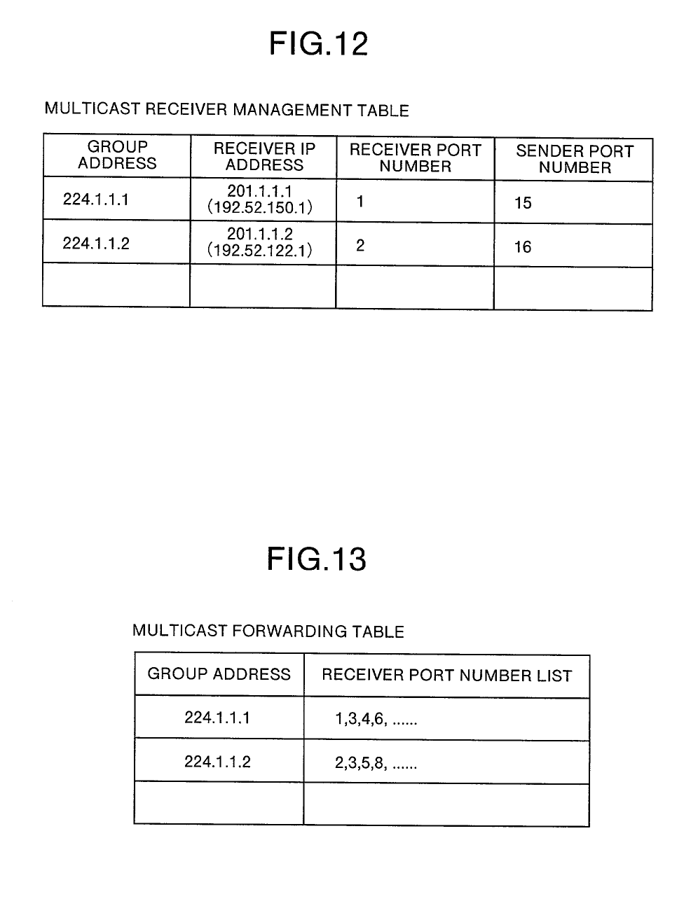

As shown in FIG. 12, the multicast receiver management table 30f consists of the group addresses of multicast groups in which the respective user PC's want to participate, receiver IP addresses, the receiver port numbers of the receiver ports of the interface to which the respective PC's are connected, and the sender port numbers of the sender ports of the interface to which the stream content delivery server 31 which delivers contents is connected. In this system, since the CE routers 22 and 23 each having the IGMP Proxy function are connected to the PE router 30, the IP addresses of the CE routers 22 and 23, for example, “201.1.1.1” and “201.1.1.2” are stored as the receiver IP addresses and the port numbers of the interface to which the CE routers 22 and 23 are connected are stored as the receiver port numbers. This management table 30f is created based on IGMP message information transmitted and received to and from the CE routers 22 and 23.

As shown in FIG. 13, the multicast forwarding table stores the group addresses of multicast groups indicating contents delivered by the stream content delivery server 31, and the receiver port number lists of the interface to which the respective user PC's (CE routers) which want to participate in the respective multicast groups are connected.

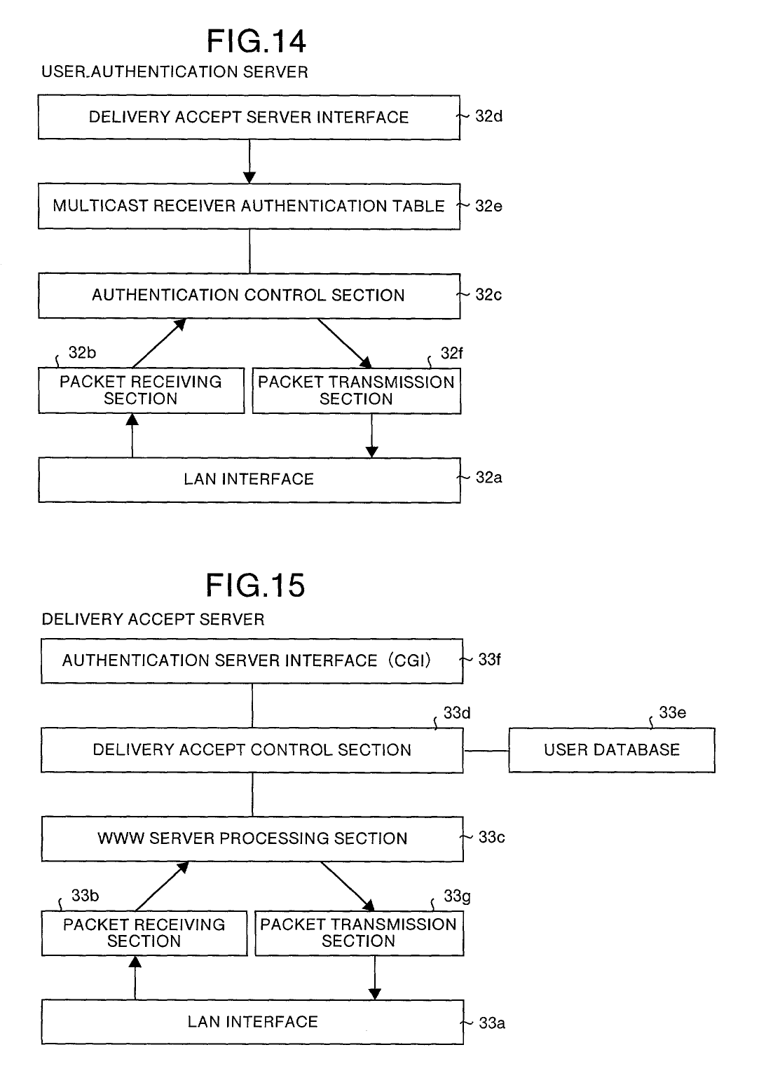

As shown in FIG. 14, the user authentication server 32 consists of a LAN interface 32a connected to the PE router 30 and the delivery accept server 33 through ports, a packet receiving section 32b receiving the packet of the RADIUS message fetched by the LAN interface 32a, an authentication control section 32c authenticating a user based on the transmitting end address and the group address in the received RADIUS message, a delivery accept server interface 32d connected to the delivery accept server 33 and inputting information on the accepted user and the like, a multicast receiver authentication table 32e registering user information input from the delivery accept server interface 32d, and a packet transmission section 32f transmitting an authentication result from the authentication control section 32c through the LAN interface 32a.

The multicast receiver authentication table 32e in the user authentication server 32 is configured as shown in FIG. 2 already described above. Also, the user authentication server 32 has a users file. This users file stores information on user names and passwords such as values of “RADIUS-CLIENT” as well as the values of “Multicast-Time-Start” which is time when a content delivery service is started and the values of “Multicast-Time-End” which is time when the content delivery service is ended as extension attributes.

As for this username information, a pair of the IP address of each receiver host and the group IP address (or only the IP address of the receiver host if all the multicast groups are designated) are registered as one user name. In this embodiment, for example, since the CE routers 22 and 23 each acting as the IGMP Proxy, the user name is “201.1.1.1-224.1.1.1” which is a combination of the IP address of the CE router, for example, the IP address “201.1.1.1” of the CE router 22 and the group IP address “224.1.1.1” and the password is “RADIUS-CLIENT”.

It is noted that this password is not set for each user PC but is a preset password used in the RADIUS packet and registered to authenticate a RADIUS client on a RADIUS protocol.

“Apr 6 21:00:00 JST 2001”, for example, is registered as the value of “Multicast-Time-Start”, namely, a content delivery service starts at 21:00:00 on Apr. 6, 2001, Japan Standard Time. “Apr 6 22:00:00 JST 2001”, for example, is registered as the value of “Multicast-Time-End”, namely, the content delivery service ends at 22:00:00 on Apr. 6, 2001, Japan Standard Time.

As shown in FIG. 15, the delivery accept server 33 consists of a LAN interface 33a connected to the PE router 30 through a port and fetching a www packet for delivery application transmitted on a Web, a packet receiving section 33b receiving the packet fetched by the LAN interface 33a, a www server processing section 33c authenticating a user based on user information in the received www packet, a delivery accept control section (WEB server) 33d accepting delivery, a user database 33e storing user account names, user passwords and the like, a user authentication server interface (CGI: Common Gateway Interface) outputting the user information to the user authentication server 32, and a packet transmission section 33g transmitting the www packet for delivery application onto the Web.

The delivery accept control section 33d expands the user information in the received packet to the database using the CGI or the like and transmits the expanded data to the user authentication server 32 through the authentication server interface 33f outputting this expanded data.

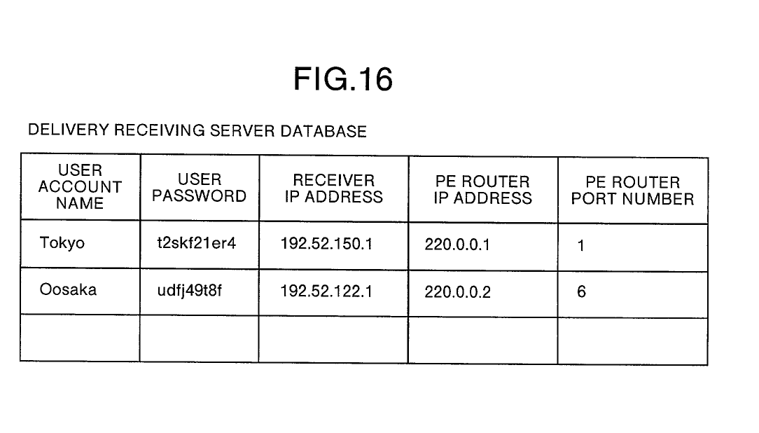

As shown in FIG. 16, the user database 33e stores the IP addresses of the ports of the PE router to which respective users are connected and the port numbers of the ports as well as the user account names and user passwords.

The accounting server 34 can charge each user for a rate based on, for example, a fixed rate system or a connection time meter rate system. In case of the fixed rate system, a monthly rate is fixed and contents in which the user can participate within this fixed rate are set to be able to be delivered to the user whenever the user applies for the delivery.

In case of the connection time meter rate system, after the user authentication server 32 authenticates a user, when a multicast stream actually flows, the PE router 30 detects the delivery of a stream and transmits data to the accounting server 34. The accounting server 34 records connection time and charges the user for a rate according to the content and the connection time.

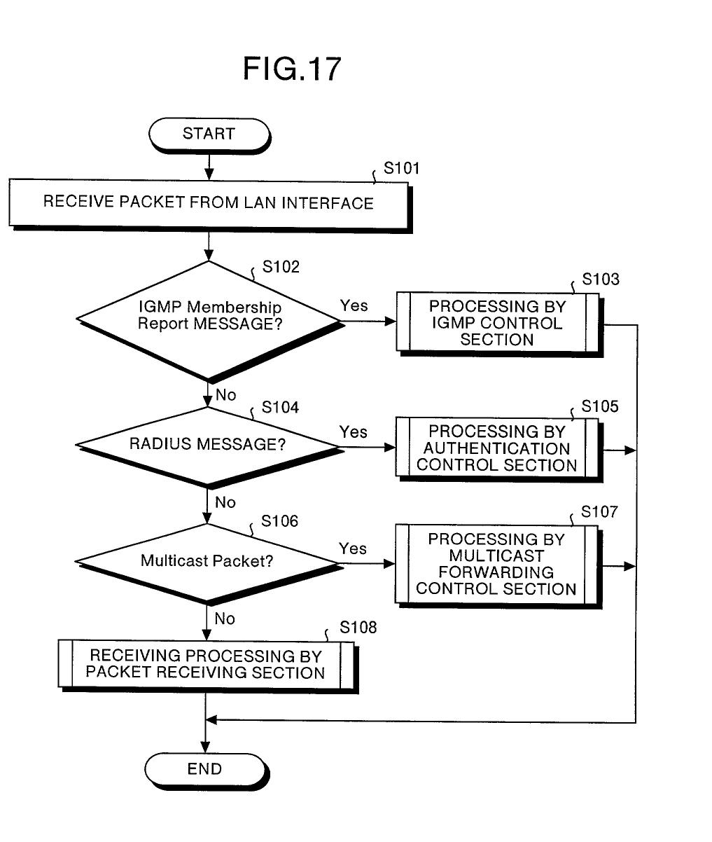

A series of operations from application for delivery to user authentication, to the delivery of a content stream in the multicast authentication system configured as stated above will be described based on flow charts shown in FIGS. 17 to 23.

FIG. 17 is a flow chart showing the received packet identification operation of the PE router 30. In FIG. 17, if the LAN interface 30a shown in FIG. 11 fetches a certain packet and the packet receiving section 30b receives the packet (in a step 101), the packet receiving section 30b determines whether the received packet is the message packet of an IGMP membership report (in a step 102).

The identification of this received packet will be described while taking a case of the message of the IGMP membership report shown in FIGS. 4 and 5 as an example. First, the packet receiving section 30b determines whether the destination address of the MAC header is the address of the PE router 30 itself. If the destination address of the MAC header is the address of the PE router 30 itself, the packet receiving section 30b retrieves an IP header and determines whether the destination address of the IP header is the address of the PE router 30 itself. If the destination address of the IP header is the address of the PE router 30 itself, the packet receiving section 30b determines whether the type of the IP is an IGMP. If the type of the IP is the IGMP and the type of the IGMP is 0×16, the packet receiving section 30b identifies the received packet as the message of the IGMP membership report.

If the received packet is the message of the IGMP membership report, the received packet is output to the IGMP control section 30c and the processing moves to a processing by the IGMP control section 30c (in a step 103). If the received packet is not the message of the IGMP membership report, the packet receiving section 30b determines whether the packet is a RADIUS message packet (in a step 104).

In that case, the packet receiving section 30b similarly retrieves the destination address in each header and the type. If the received packet is the RADIUS message packet, the received packet is output to the authentication control section 30d and the processing moves to a processing by the authentication control section 30d (in a step 105). If the received packet is not the RADIUS message packet, the packet receiving section 30b determines whether the packet is a multicast packet (in a step 106).

Likewise, the destination address of the MAC header is retrieved. If the destination address is the address of the CE router, then the packet receiving section 30b determines that the received packet is the multicast packet and outputs the received packet to the multicast forwarding control section 30e and the processing moves to a processing by the multicast forwarding control section 30e (in a step 107). If the received packet is not the multicast packet, the packet is subjected to a receiving processing by the packet receiving section 30b (in a step 108) and transmitted from, for example, the packet transmission section 30h. The packet taking such steps may be exemplified by a participation application packet transmitted and received between each of the user PC's 20 and 21 and the stream content delivery server 31.

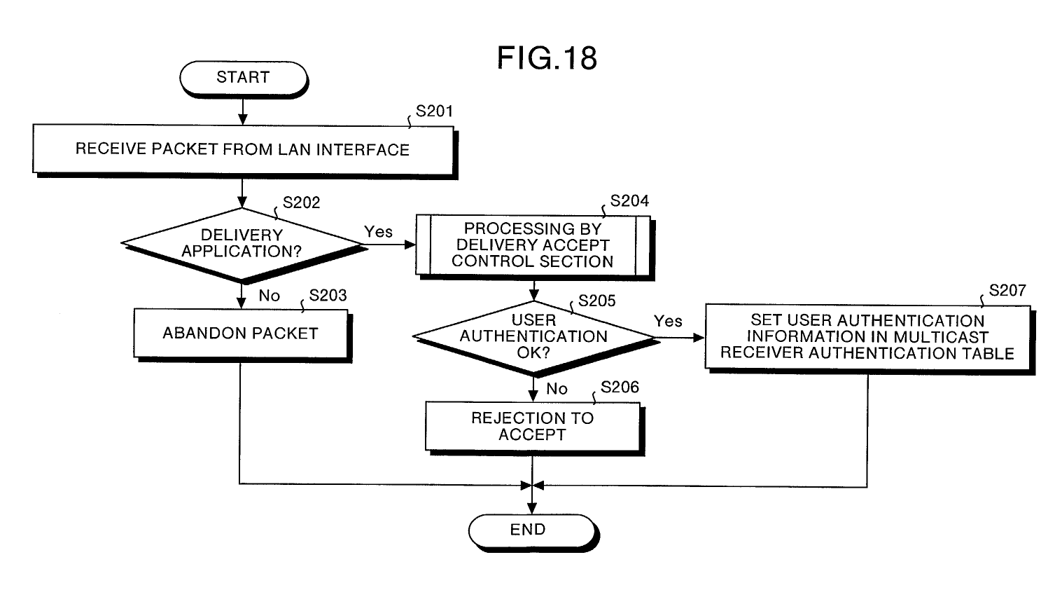

The delivery accept operation of the delivery accept server 33 will be described based on a flow chart shown in FIG. 18.

Before starting the description of this delivery accept operation, the service provider opens a schedule for contents to be delivered through the IP network 29 on a Web page, and the user views this Web page, makes a user registration and receives a user account name and a password. In case of the receiver host 20, for example, the account and the password thereof are “Tokyo” and “t2skf21er4” shown in FIG. 16, respectively. In case of the receiver host 21, the account and the password thereof are “Oosaka” and “udfj49t8f”, respectively.

The user provider creates multicast content delivery accounts for the respective network users. The user who made a user registration starts the browser of the user PC 20, for example, connects to a www server on which the content schedule opened by the service provider is displayed and transmits data for delivery application.

This data consists of a www packet. After the data is subjected to the relay processing by the CE router 22, the packet is identified by the PE router 30 as stated above and transmitted to the delivery accept service 33.

As shown in FIG. 18, in the delivery accept server 33, the packet receiving section 33b receives the above-stated packet fetched (in a step 201).

The packet receiving section 33b determines whether the received packet is a www packet (in a step 202). If the received packet is not the www packet, the packet receiving section 33b determines the received packet as an unnecessary packet and abandons the packet (in a step 203). If the received packet is the www packet, the packet receiving section 33b outputs this received packet to the www server processing section 33c and the user account name and the password are output to the delivery accept control section 33d (in a step 204). The delivery accept control section 33d performs processings for delivery accept such as checking of the user account name and the password in the database 33e, to thereby authenticate the user (in a step 205).

If the user is not authenticated, the delivery accept control section 33d determines that a correct setting is not made and rejects to accept the delivery application (in a step 206). If the user is authenticated, the delivery accept control section 33d extracts the PE router IP address, the port number and the user IP address and provides these pieces of user authentication information to the multicast receiver authentication table 32e in the user authentication server 32 through the authentication server interface 33f (in a step 207).

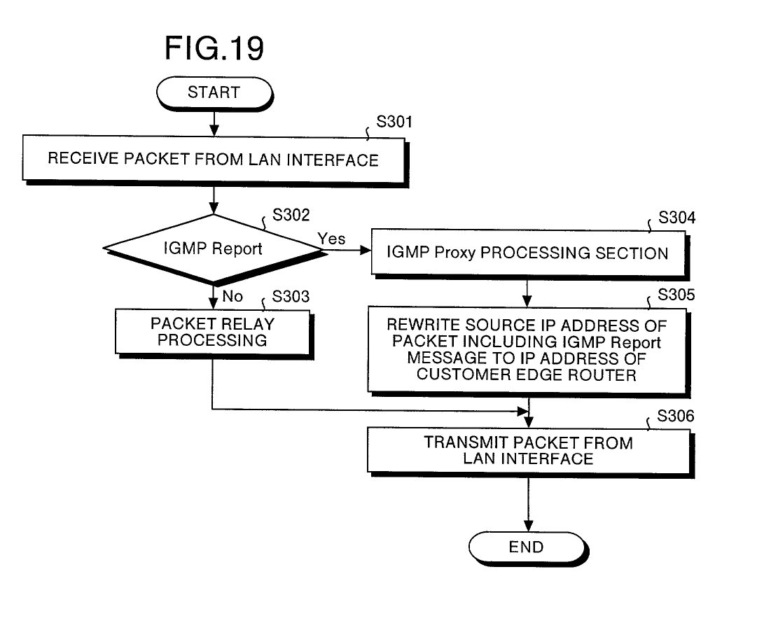

During the above-stated packet transmission, the CE router 22 between the user PC and the PE router 30 performs a relay operation based on a flow chart shown in FIG. 19. In FIG. 19, if the LAN interface 22a fetches the packet and the packet receiving section 22b receives the packet (in a step 301), the packet receiving section 22b determines whether the received packet is the message packet of an IGMP membership report (in a step 302).

If the received packet is not the message packet of an IGMP membership report, then the packet receiving section 22b determines the packet as an ordinary data communication packet, outputs the packet to the packet relay processing section 22d and subjects this received packet to an ordinary packet relay processing (in a step 303). If the received packet is the message packet of an IGMP membership report, the packet receiving section 22b outputs this packet to the IGMP Proxy processing section (in a step 304). In the IGMP Proxy processing section, the transmitting end address of the message packet of the IGMP membership report is rewritten from the IP address of the user PC 20 to the IP address of the CE router 22 (in a step 305). After the step 303 or 305, the packet processing section 22e transmits this received packet through the LAN interface 22a (in a step 306).

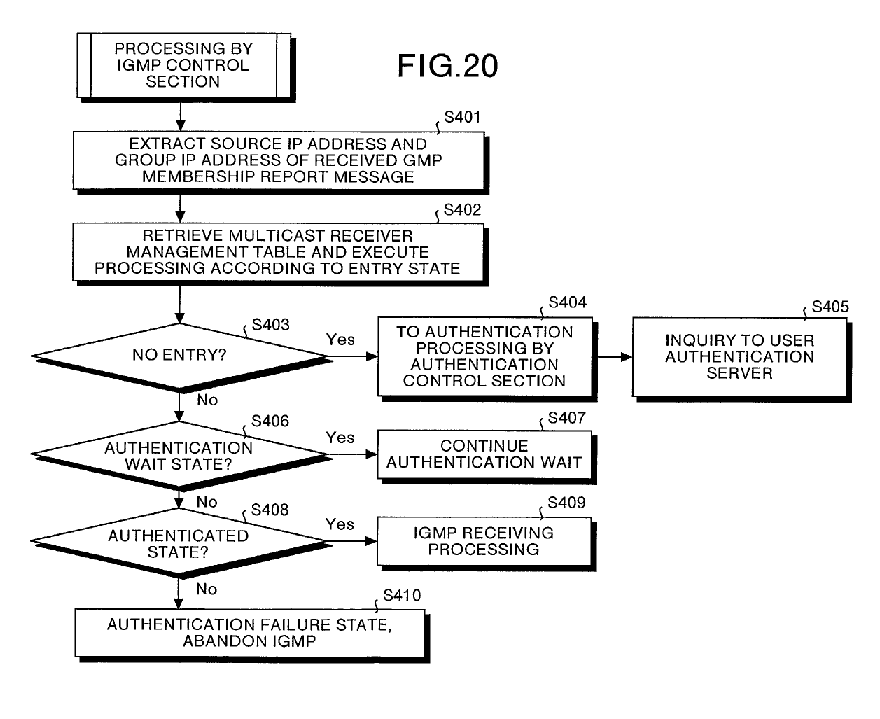

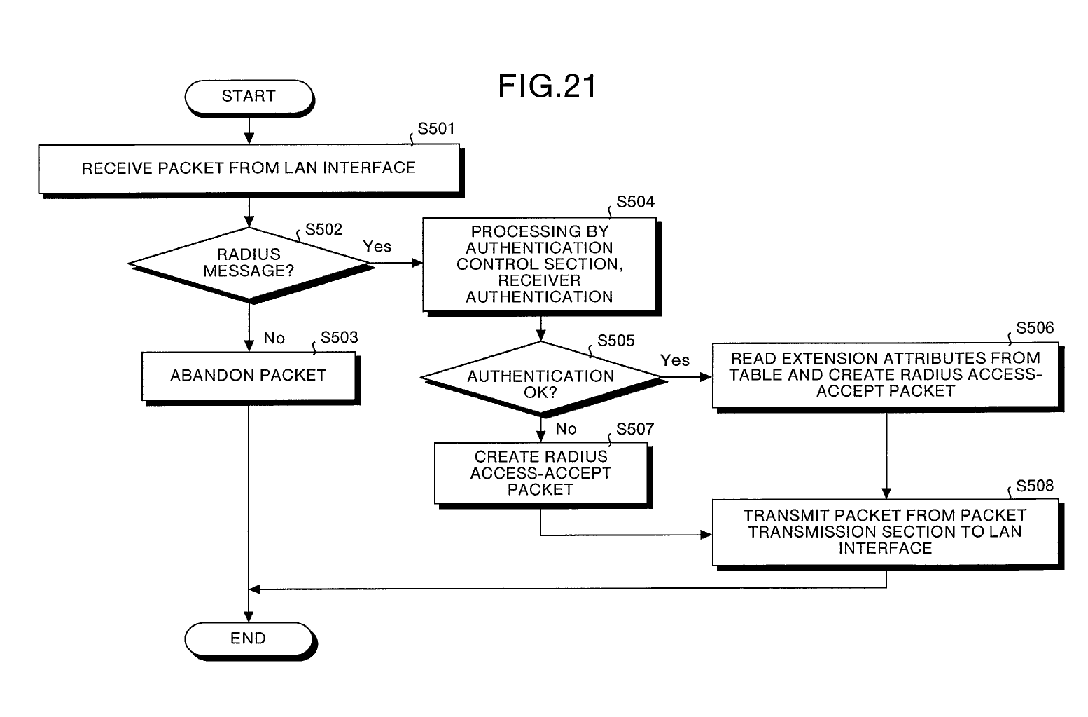

Description will be given to the processing operations of the PE router 30 and the user authentication server 32 following the transmission and receiving of the message packet of the IGMP membership report, based on flow charts shown in FIGS. 20 and 21. First, if the group address of a multicast group to be received by the user PC 20 is transmitted as the message of the IGMP membership report to the PE router 30 and the PE router 30 recognizes this message in the step 102 shown in FIG. 17, the IGMP control section 30e (see FIG. 11) executes a processing flow shown in FIG. 20.

In FIG. 20, the IGMP control section 30e extracts the transmitting end IP address of the message of the received IGMP membership report and the group IP address (in a step 401), retrieves information in the multicast receiver management table 30f based on these addresses and executes the processing in accordance with an entry state (in a step 402).

In a step 403, if there is no entry, the processing moves to an authentication processing by the authentication control section 30d (in a step 404) and an “Access-Request” RADIUS message packet for inquiring about authentication based on this transmitting end IP address and the group IP address of the multicast group for which the user issues a participation request is transmitted to the user authentication server 32 (in a step 405).

If an entry is found as a result of this inquiry, it is determined that there is an entry in the step 403 and then it is determined whether the present state is a wait state for the user authentication server to make authentication (in a step 406).

If no authentication result is received in response to the above-stated inquiry, an authentication wait state is continued until the authentication result is received (in a step 407). If the present state is not the authentication wait state, it is then determined whether the state is a user authenticated state (in a step 408).

If the user is already authenticated, the packet receiving section 30b performs a normal IGMP receiving processing (in a step 409). If the user is not authenticated yet, it is determined that the state is an authentication failure state and the IGMP is abandoned (in a step 410). In this way, if the state is the authentication failure state, the corresponding entry of the multicast receiver management table is deleted in the processing operation of the authentication control section 30d to be described later. Consequently, the above-stated operation is not repeatedly performed and an inquiry to the user authentication server 32 is held.

If the user authentication server 32 receives the inquiry as shown in the step 405 of FIG. 20, the user authentication server 32 performs the operation shown in the flow chart of FIG. 21. Namely, if the LAN interface 32a fetches the packet and the packet receiving section 32b receives the packet (in a step 501), the packet receiving section 32b determines whether the received packet is a RADIUS message indicating an inquiry (in a step 502).

If the received packet is not the RADIUS message indicating an inquiry, the packet receiving section 32b abandons the received packet (in a step 503). If the received packet is the RADIUS message indicating an inquiry, the authentication control section 32c performs an authentication processing in which the authentication of the receiver is conducted based on the user name consisting of the IP address of the receiver host and the group IP address in the RADIUM message (in a step 504).

In a step 505, if the receiver host is authenticated, the authentication control section 32c reads the content delivery service start time and end time serving as extension attributes from the multicast receiver authentication table 32e and creates an “Access-Accept” RADIUS message (in a step 506). If the receiver host is not authenticated, the authentication control section 32c creates an “Access-Reject” RADIUS message (in a step 507). The RADIUS message thus created is transmitted from the packet transmission section 32f to the LAN interface through the LAN interface 32a (in a step 508).

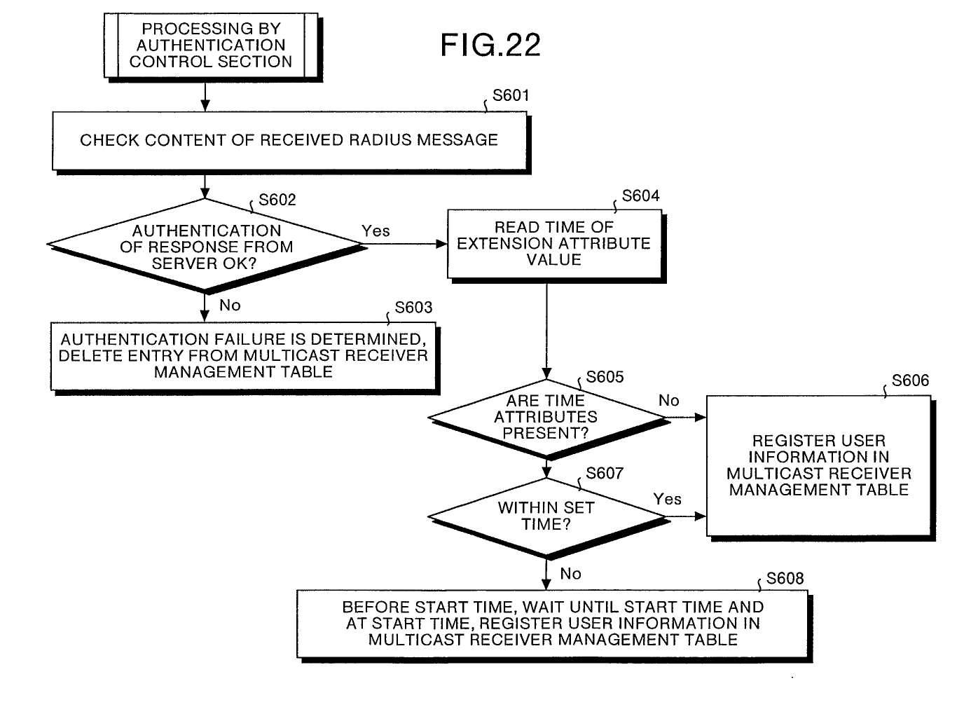

The authentication control operation of the authentication control section 30d of the PE router 30 shown in FIG. 11 will be described based on a flow chart shown in FIG. 22. In FIG. 17, if the packet receiving section 30b identifies the received packet as the RADIUS message, the processing moves to a processing by the authentication control section 30d and the authentication control section 30d checks the content of the received RADIUS message (in a step 601). Then, the authentication control section 30d determines whether a response from the user authentication server 32 is the acceptance of the authentication (in a step 602).

If this authentication is not accepted, the authentication control section 30d determines that authentication fails and deletes the corresponding entry from the multicast receiver management table 30f (in a step 603). If this authentication is accepted, the authentication control section 30d reads the time as the extension attribute value (in a step 604) and determines whether there are time attributes (in a step 605).

If the time attributes are not set, the user information is registered in the multicast receiver management table 30f (in a step 606). If the time attributes are set, it is then determined whether the present time is within the set time as the extension attribute value (in a step 607).

If the present time is out of the set time or before the set start time, in particular, the authentication control section 30d starts an internal timer, for example, and waits until the start time. At the start time, the authentication control section 30d registers the user information in the multicast receiver management table 30f (in a step 608). If the present time is within the set time, the authentication control section 30d registers the user information in the multicast receiver management table 30f (in a step 606).

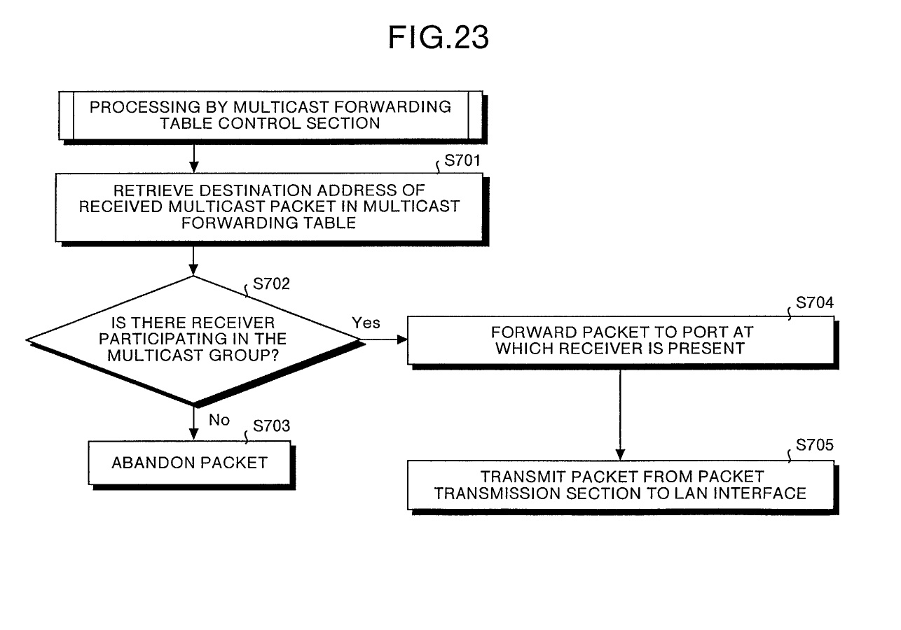

The forwarding processing operation of the multicast forwarding control section 30e of the PE router 30 shown in FIG. 11 will be explained based on a flow chart shown in FIG. 23. If the packet receiving section 30b identifies the received packet as the multicast packet in FIG. 17, the processing moves to a processing by the multicast forwarding control section 30e. The multicast forwarding control section 30e retrieves the destination address of the received multicast packet (group address) in the multicast forwarding table 30g (in a step 701).

The multicast forwarding control section 30e determines whether there is a receiver participating in the multicast group having this group address (in a step 702).

If there is not a participating receiver, the multicast forwarding control section 30e abandons the received packet (in a step 702). If there is such a receiver, the multicast forwarding control section 30e forwards the packet to the port having the receiver port number at which port the receiver is present (in a step 704). The packet is then transmitted from the packet transmission section 30h through the LAN interface 30a (in a step 705).

As can be understood from the above, in this embodiment, the user PC (receiver host) which can participate in a multicast group is registered in the user authentication server in advance by application for participation. If a membership report indicating a participation request is transmitted from the user PC using the IGMP, it is determined whether the user PC is authenticated based on the information in this report and the registration content of this user authentication server. If the user PC is authenticated, the user PC is accepted to participate in the multicast group within the accepted time. It is, therefore, possible to accurately authenticate the user PC while the function of the user PC remains as it is.

In this embodiment, since accepted time for the user PC to participate in the multicast group is set in the user authentication server, the user PC accepted to participate in the multicast group can forward the multicast packet for necessary time but within the accepted time.

In this embodiment, since a pair of the transmitting end address and the group address is set as one user name and the user is authenticated based on the user name, it is not necessary to provide the respective user PC's with individual passwords, thereby making it possible to inquire of the user authentication server by entering the preset password at the time of conducting procedures for the participation application or the participation request.

While the user authentication server determines whether the user PC is authenticated to be accepted to participate in this embodiment, the present invention is not limited thereto. Alternatively, the PE router, for example, can be provided with this authentication function to determine whether the user is authenticated. In the latter case, the user authentication server is set to include a multicast receiver authentication table and to transmit the registration content of this table to the PE router in response to a request from the PE router.

In the first embodiment, description has been given to a case where the PE router 30 conducts the IGMP control, the authentication control and the multicast forwarding control. The present invention is not limited thereto. Alternatively, the CE routers 22 and 23 may exercise these controls.

In the latter case, the configuration of each of the CE routers 22 and 23 is the same as that of the PE router 30 shown in FIG. 11 and the PE router 30 is set to have a packet relay function.

In that case, if user authentication determination is conducted by each of the CE routers 22 and 23, for example, the IP address of the IGMP message used for the authentication is the receiver IP address and the IP address of each of the user PC's 20 and 21 is, therefore, used as it is.

For these reasons, the multicast receiver management tables to be included in the CE routers 22 and 23 store the addresses of the user PC's 20 and 21, for example, “192.52.150.1” and “192.52.122.1” as the receiver IP addresses, respectively, and the addresses of the user PC's 20 and 21 are stored in the receiver port numbers, respectively.

As can be understood from the above, in this embodiment, the receiver host which can participate in a multicast group is registered in the user authentication server in advance by participation application. If a membership report indicating a participation request is transmitted from the receiver host using the IGMP, it is determined whether the receiver host is authenticated based on the information in this report and the registration content of this user authentication server. If the receiver host is authenticated, the receiver host is accepted to participate in the multicast group within the accepted time. It is, therefore, possible to accurately authenticate the receiver host while the function of the receiver host remains as it is.

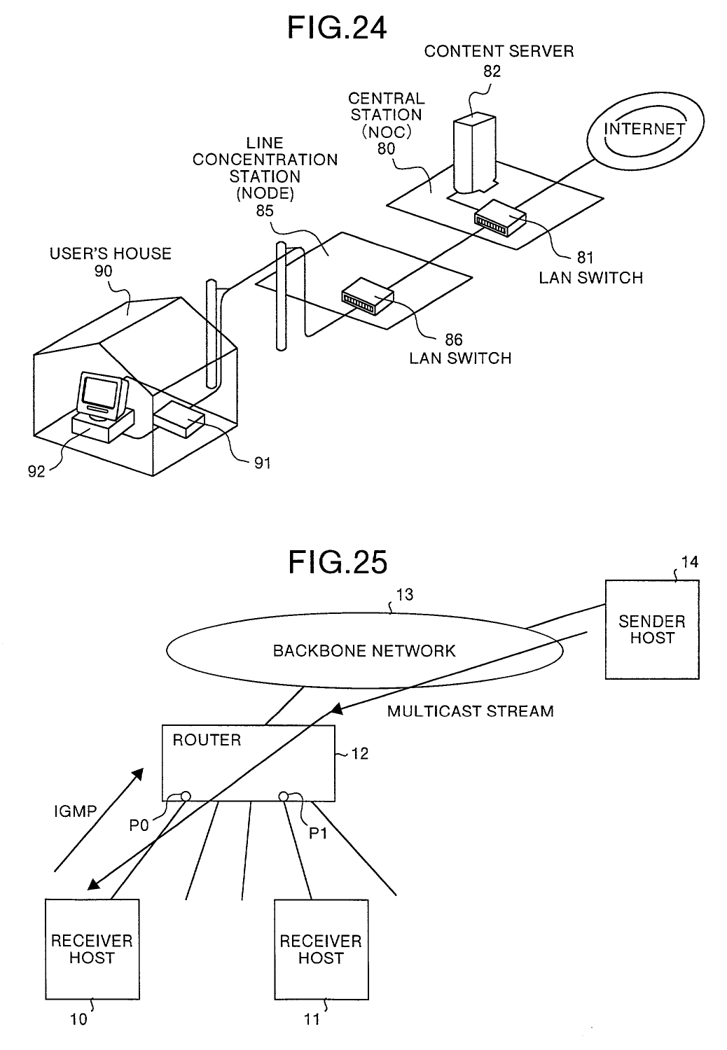

The authentication system according to the present invention can be used as a constant connection network for an FTTH (Fiber to the Home) service as shown, for example, in FIG. 24 which shows the second embodiment according to the present invention. In FIG. 24, a LAN switch 81 and a content server 82 are present in a central station 80, a LAN switch 86 is present in a line concentration station 85, and a media converter 91 and a receiver host 92 are present in a user's house 90.

Even with the above-stated configuration, it is possible to provide either the LAN switch 81 or 86 with the IGMP control functions, the authentication control function and the multicast forwarding control function as in the case of the first embodiment and to thereby provide a delivery service by the content server 82. Further, a unit which authenticates the user may be provided in the central station 80 or in the Internet network.

As a result, in the second embodiment as in the case of the first embodiment, the receiver host which can participate in a multicast group is registered in the user authentication server in advance by participation application. If a membership report indicating a participation request is transmitted from the receiver host using the IGMP, it is determined whether the receiver host is authenticated based on the information in this report and the registration content of this user authentication server. If receiver host is authenticated, the receiver host is accepted to participate in the multicast group within the accepted time. It is, therefore, possible to accurately authenticate the receiver host while the function of the receiver host remains as it is.

The present invention should not be limited to the above-stated embodiments and various changes and modifications can be executed within the scope of the invention. For example, the present invention is applicable to a moving picture delivery service for video programs such as VOD (video on demand).

As stated so far, according to the present invention, the address of the receiver host which can participate in a multicast group or the address of the relay router is registered in the authentication server. If an IGMP membership report indicating a participation request is transmitted from the receiver host, it is determined whether the receiver host is authenticated based on the information in this report and the registration content of this authentication server. If the receiver host is authenticated, the receiver host is accepted to participate in the multicast group. It is, therefore, possible to accurately authenticate the receiver host while the function of the receiver host remains as it is.

According to the present invention, information on the port of the router to which the receiver host or the relay router is connected as well as the address of the receiver host or the relay router is registered in the authentication server. If an IGMP membership report indicating a participation request is transmitted from the receiver host, it is determined whether the receiver host is authenticated based on the information in this report and the registration content of this authentication server. If the receiver host is authenticated, the receiver host is accepted to participate in the multicast group. It is, therefore, possible to accurately authenticate the receiver host while the function of the receiver host remains as it is.

According to the present invention, the group address of the multicast group is also registered in the authentication server. If an IGMP membership report indicating a participation request is transmitted from the receiver host, it is determined whether the receiver host is authenticated based on the information in this report and the registration content of this authentication server. If the receiver host is authenticated, the receiver host is accepted to participate in the multicast group. It is, therefore, possible to accurately authenticate the receiver host while the function of the receiver host remains as it is.

In addition, according to the present invention, the address of the receiver host or the relay router is registered in the authentication server according to the participation of the receiver host in all the multicast groups. If an IGMP membership report indicating a participation request is transmitted from the receiver host, it is determined whether the receiver host is authenticated based on the information in this report and the registration content of this authentication server. If the receiver host is authenticated, the receiver host is accepted to participate in the multicast group. It is, therefore, possible to accurately authenticate the receiver host while the function of the receiver host remains as it is.

According to the present invention, accepted time for which the receiver host is accepted to participate in the multicast group is also registered in the authentication server. If an IGMP membership report indicating a participation request is transmitted from the receiver host, it is determined whether the receiver host is authenticated based on the information in this report and the registration content of this authentication server. If the receiver host is authenticated, the receiver host is accepted to participate in the multicast group. It is, therefore, possible to accurately authenticate the receiver host while the function of the receiver host remains as it is.

According to the present invention, by combining the above-stated authentication function with the accounting function, it is possible to accurately charge the receiver host for a rate and the service provider can thereby deliver paid contents.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A multicast authentication method for connecting a plurality of receiver hosts and a network of a sender host through a network interconnection apparatus and authenticating participate of the sender host in one multicast group by an authentication server in the network, the method comprising:
a registration step of registering an address of each of the receiver hosts in the authentication server in accordance with an application for the participation in the one multicast group of the sender host from each of the receiver hosts; and
an authentication step of authenticating each of the receiver hosts based on a registration content of the authentication server in response to a participation request message from the receiver host.

2. The multicast authentication method according to claim 1, further comprising an acceptance step of accepting each of the receiver hosts to participate in the one multicast group of the receiver host if the receiver host is authenticated in response to the participation request message.

3. The multicast authentication method according to claim 2, wherein
in the acceptance step, when a multicast user registration is made in the registration step and it is determined in the authentication step that authentication fails, an entry of the multicast user registration is deleted in the acceptance step.

4. The multicast authentication method according to claim 1, wherein
in the registration step, information on a port of said network interconnection apparatus to which the each receiver host or the relay unit is connected is registered together with the address of the receiver host or the relay unit in the authentication server.

5. The multicast authentication method according to claim 1, wherein
in the registration step, a group address of the multicast group is further registered in the authentication server; and
in the authentication step, the each receiver host or the relay unit and the one multicast group are authenticated based on the registration content of the authentication server in response to the participation request message from the each receiver host.

6. The multicast authentication method according to claim 5, wherein
in the registration step, a pair of the address of the each receiver host or the relay unit and the group address of the one multicast group are registered as one user name; and
in the authentication step, a transmitting end address and the group address included in the participation request message are extracted, and the registration content of the authentication server is retrieved and the each receiver host or the relay unit is authenticated while setting a pair of the transmitting end address and the group address as one user name.

7. The multicast authentication method according to claim 1, wherein
in the registration step, the address of the each receiver host or the relay unit is registered in the authentication server in response to an application for participation of the receiver host in all the multicast groups; and
in the acceptance step, if the each receiver host is authenticated in response to the participation request message, the receiver host is accepted to participate in all the multicast groups.

8. The multicast authentication method according to claim 1, wherein
in the registration step, accepted time for accepting the each receiver host to participate in the one multicast group is further registered in the authentication server; and
in the acceptance step, if the each receiver host is authenticated in response to the participation request message, the receiver host is accepted to participate in the one multicast group within the accepted time.

9. The multicast authentication method according to claim 8, wherein
in the acceptance step, the accepted time is preset for each of the multicast groups, the accepted time is set for each of the receiver hosts based on participation time for participating in the one multicast group designated by the each receiver host and the accepted time thus set is registered in the authentication server when the participation application is made.

10. The multicast authentication method according to claim 8, wherein
in the acceptance step, the accepted time is preset for each of the multicast groups, and the accepted time is registered in the authentication server based on the one multicast group designated by the each receiver host when the participation application is made.

11. The multicast authentication method according to claim 8, wherein
the authentication step is executed by the authentication server, and if the each receiver host is registered as a user together with an authentication result, information on the accepted time serving as the registration content is transmitted to said network interconnection apparatus; and
the acceptance step is executed by said network interconnection apparatus, said network interconnection apparatus determines that the participation is accepted based on the authentication result received and accepts the participation of the each receiver host in the multicast group within the accepted time received.

12. The multicast authentication method according to claim 8, wherein
the authentication step and the acceptance step are executed by said network interconnection apparatus, and the authentication server transmits a user registration content for the designated transmitting end address and the designated one multicast group to said network interconnection apparatus when the participation application is made; and
the network interconnection apparatus determines whether the each receiver host is authenticated based on the registration content, determines whether the participation of the each receiver host is accepted based on the authentication result and accepts the each receiver host to participate in the multicast address group within the accepted time.

13. The multicast authentication method according to claim 8, wherein
in the authentication step, before the accepted time, it is determined the authentication as a failure.

14. The multicast authentication method according to claim 1, wherein
in the multicast authentication method, the sender host is the Internet service provider, the service provider providing a content stream delivery service by a delivery server; and in the acceptance step, a content stream delivered from the delivery server within the accepted time is multicast-forwarded to the accepted receiver host.

15. The multicast authentication method according to claim 1, further comprising an accounting step of charging for an executed service.

16. A multicast authentication method for connecting a plurality of receiver hosts and a network of a sender host through a network interconnection apparatus and a relay unit, and authenticating participate of the sender host in one multicast group by an authentication server in the network, the method comprising:
a registration step of registering an address of the relay unit to which the each receiver host is connected in accordance with an application for the participation in the one multicast group of the sender host from each of the receiver hosts; and
an authentication step of authenticating the relay unit based on a registration content of the authentication server in response to a participation request message from the receiver host.

17. The multicast authentication method according to claim 16, further comprising an acceptance step of accepting each of the receiver hosts to participate in the one multicast group of the receiver host if the receiver host is authenticated in response to the participation request message.

18. The multicast authentication method according to claim 17, wherein
in the acceptance step, if a multicast user registration is made in the registration step and it is determined in the authentication step that authentication fails, an entry of the multicast user registration is deleted in the acceptance step.

19. The multicast authentication method according to claim 16, wherein
in the registration step, information on a port of said network interconnection apparatus to which the each receiver host or the relay unit is connected is registered together with an address of the each receiver host or the address of the relay unit in the authentication server.

20. The multicast authentication method according to claim 16, wherein
in the registration step, a group address of the multicast group is further registered in the authentication server; and
in the authentication step, the each receiver host or the relay unit and the one multicast group are authenticated based on the registration content of the authentication server in response to the participation request message from the each receiver host.

21. The multicast authentication method according to claim 20, wherein
in the registration step, a pair of the address of the each receiver host or the relay unit and the group address of the one multicast group are registered as one user name; and
in the authentication step, a transmitting end address and the group address included in the participation request message are extracted, and the registration content of the authentication server is retrieved and the each receiver host or the relay unit is authenticated while setting a pair of the transmitting end address and the group address as one user name.

22. The multicast authentication method according to claim 16, wherein
in the registration step, an address of the each receiver host or the address of the relay unit is registered in the authentication server in response to an application for participation of the receiver host in all the multicast groups; and
in the acceptance step, if the each receiver host is authenticated in response to the participation request message, the receiver host is accepted to participate in all the multicast groups.

23. The multicast authentication method according to claim 16, wherein
in the registration step, accepted time for accepting the each receiver host to participate in the one multicast group is further registered in the authentication server; and
in the acceptance step, if the each receiver host is authenticated in response to the participation request message, the receiver host is accepted to participate in the one multicast group within the accepted time.

24. The multicast authentication method according to claim 23, wherein
in the acceptance step, the accepted time is preset for each of the multicast groups, the accepted time is set for each of the receiver hosts based on participation time for participating in the one multicast group designated by the each receiver host and the accepted time thus set is registered in the authentication server when the participation application is made.

25. The multicast authentication method according to claim 23, wherein
in the acceptance step, the accepted time is preset for each of the multicast groups, and the accepted time is registered in the authentication server based on the one multicast group designated by the each receiver host when the participation application is made.

26. The multicast authentication method according to claim 23, wherein
the authentication step is executed by the authentication server, and if the each receiver host is registered as a user together with an authentication result, information on the accepted time serving as the registration content is transmitted to said network interconnection apparatus; and
the acceptance step is executed by said network interconnection apparatus, said network interconnection apparatus determines that the participation is accepted based on the authentication result received and accepts the participation of the each receiver host in the multicast group within the accepted time received.

27. The multicast authentication method according to claim 23, wherein
the authentication step and the acceptance step are executed by said network interconnection apparatus, and the authentication server transmits a user registration content for the designated transmitting end address and the designated one multicast group to said network interconnection apparatus when the participation application is made; and
the network interconnection apparatus determines whether the each receiver host is authenticated based on the registration content, determines whether the participation of the each receiver host is accepted based on the authentication result and accepts the each receiver host to participate in the multicast address group within the accepted time.

28. The multicast authentication method according to claim 23, wherein
in the authentication step, before the accepted time, it is determined the authentication as a failure.

29. The multicast authentication method according to claim 16, wherein
in the multicast authentication method, the sender host is the Internet service provider, the service provider providing a content stream delivery service by a delivery server; and in the acceptance step, a content stream delivered from the delivery server within the accepted time is multicast-forwarded to the accepted receiver host.

30. The multicast authentication method according to claim 16, further comprising an accounting step of charging for an executed service.

31. An authentication server provided in a network of a sender host, comprising a registration unit which registers an address of a receiver host connected to a network of a sender host in accordance with a participation application for participating in a multicast group of the sender host from the receiver host.

32. The authentication server according to claim 31, further comprising:
an authentication unit which determines whether the participation is authenticated based on a registration content of the registration unit in response to a participation request message from the receiver host; and
a transmission unit which transmits an authentication result of the authentication unit.

33. The authentication server according to claim 32, wherein
the transmission unit transmits the registration content of the registration unit in response to the participation request message from the receiver host.

34. The authentication server according to claim 31, wherein
the registration unit registers, together with the address of the receiver host or an address of the relay unit, information on a predetermined port to which the receiver host or the relay unit is connected.

35. The authentication server according to claim 31, wherein
the registration unit registers, together with the address of the receiver host or an address of the relay unit, a group address of the multicast group for which the participation application is made.

36. The authentication server according to claim 35, wherein
the registration unit registers a pair of the address of the receiver host or the address of the relay unit and the group address of the multicast group as one user name; and the authentication unit retrieves the registration content of the registration unit and determines whether the receiver host or the relay unit is authenticated while setting a pair of a transmitting end address included in the participation request message and the group address as one user name.

37. The authentication server according to claim 31, wherein
the registration unit further registers accepted time for accepting the receiver host to participate in the multicast group.

38. The authentication server according to claim 31, further comprising a control unit which allows the accepted time to be registered in the registration unit based on participation time for participating in the multicast group designated by the receiver host when the participation application is made.

39. The authentication server according to claim 31, further comprising a control unit which allows the accepted time to be registered in the registration unit based on the multicast group designated by the receiver host when the participation application is made.

40. An authentication server provided in a network of a sender host, comprising a registration unit which registers an address of a receiver host connected to a network of a sender host through a relay unit in accordance with a participation application for participating in a multicast group of the sender host from the receiver host.

41. The authentication server according to claim 40, further comprising:
an authentication unit which determines whether the participation is authenticated based on a registration content of the registration unit in response to a participation request message from the receiver host; and
a transmission unit which transmits an authentication result of the authentication unit.

42. The authentication server according to claim 41, wherein
the transmission unit transmits the registration content of the registration unit in response to the participation request message from the receiver host.

43. The authentication server according to claim 40, wherein
the registration unit registers, together with an address of the receiver host or the address of the relay unit, information on a predetermined port to which the receiver host or the relay unit is connected.

44. The authentication server according to claim 40, wherein
the registration unit registers, together with an address of the receiver host or the address of the relay unit, a group address of the multicast group for which the participation application is made.

45. The authentication server according to claim 44, wherein
the registration unit registers a pair of the address of the receiver host or the address of the relay unit and the group address of the multicast group as one user name; and the authentication unit retrieves the registration content of the registration unit and determines whether the receiver host or the relay unit is authenticated while setting a pair of a transmitting end address included in the participation request message and the group address as one user name.

46. The authentication server according to claim 40, wherein
the registration unit further registers accepted time for accepting the receiver host to participate in the multicast group.

47. The authentication server according to claim 40, further comprising a control unit which allows the accepted time to be registered in the registration unit based on participation time for participating in the multicast group designated by the receiver host when the participation application is made.

48. The authentication server according to claim 40, further comprising a control unit which allows the accepted time to be registered in the registration unit based on the multicast group designated by the receiver host when the participation application is made.

49. A network interconnection apparatus connected to a plurality of receiver hosts and connected to an authentication server through a network of a sender host, comprising:
a transmission processing unit which extracts a transmitting end address of a participation request message received from each of the receiver hosts, creates a message inquiring about authentication information, and conducts a transmission processing for transmitting the created message to the authentication server; and
an acceptance unit which accepts participation of the each receiver host in the multicast group based on an authentication result message received from the authentication server.

50. The network interconnection apparatus according to claim 49, wherein
said network interconnection apparatus further comprises a management table for managing receivers of the multicast group; and
the transmission processing unit determines whether an entry of the extracted transmitting end address exists in the management table, and for transmitting the message inquiring about the authentication information based on a determination result.

51. The network interconnection apparatus according to claim 50, wherein
the acceptance unit deletes the corresponding entry registered in the management table if the authentication result of the authentication server shows that authentication fails.

52. The network interconnection apparatus according to claim 49, wherein
the transmission processing unit extracts a group address as well as the transmitting end address of the received participation request message, creates the message inquiring about the authentication information, and conducts the transmission processing for transmitting the created message to the authentication server.

53. The network interconnection apparatus according to claim 49, wherein
the acceptance unit accepts participation of the each receiver host in the multicast group within accepted time based on the authentication result message received from the authentication server.

54. The network interconnection apparatus according to claim 53, wherein
the acceptance unit deletes the corresponding entry registered in the management table if the authentication result of the authentication server shows that authentication fails.

55. The network interconnection apparatus according to claim 54, wherein
the sender host is the Internet service provider, the service provider comprising a delivery server delivering a content stream, the delivery server provided in the network; and the acceptance unit of said network interconnection apparatus multicast-forwards a packet of the content stream delivered from the delivery server to the accepted each receiver host within the accepted time.

56. The network interconnection apparatus according to claim 49, wherein
the sender host is the Internet service provider, the service provider comprising a delivery server delivering a content stream, the delivery server provided in the network; and the acceptance unit of said network interconnection apparatus multicast-forwards a packet of the content stream delivered from the delivery server to the accepted each receiver host.

57. The network interconnection apparatus according to claim 56, wherein
the sender host is the Internet service provider, the service provider comprising the delivery server delivering the content stream, the delivery server provided in the network; and the acceptance unit of said network interconnection apparatus multicast-forwards the packet of the content stream delivered from the delivery server to the accepted each receiver host within the accepted time.

58. A multicast authentication system comprising: a plurality of receiver hosts; a network of a sender host; a network interconnection apparatus for connecting the plurality of receiver hosts to the network; and an authentication server provided in the network, wherein
the authentication server, provided in the network of the sender host, comprises a registration unit which registers an address of one of the receiver hosts connected to the network of the sender host in accordance with a participation application for participating in a multicast group of the sender host from the receiver host;
said network interconnection apparatus, connected to the plurality of receiver hosts and connected to the authentication server through the network of the sender host, comprises a transmission processing unit which extracts a transmitting end address of a participation request message received from the one receiver host, creates a message inquiring about authentication information, and conducts a transmission processing for transmitting the created message to the authentication server; and an acceptance unit which accepts participation of the one receiver host in the multicast group based on an authentication result message received from the authentication server; and
the authentication server authenticates the participation of the one receiver host in the multicast group of the sender host, and said network interconnection apparatus accepts the receiver host to participate in the multicast group.

59. The multicast authentication system according to claim 58, further comprising:
a relay unit connected between the network interconnection apparatus and the plurality of receiver hosts, the relay unit changing the transmitting end address of the participation request message transmitted from the one receiver host to an address of the relay unit itself and relaying the changed address to said network interconnection apparatus, the relay unit changing a destination address a packet transmitted from said network interconnection apparatus, the destination address being the address of the relay unit itself, to the address of the one receiver host issuing the participation request and relaying the changed address to the one receiver host.

60. The multicast authentication system according to claim 58, wherein the multicast authentication system further comprises a delivery server provided in the network and delivering a content stream, and multicast-forwards a packet of the content stream delivered from the delivery server to the accepted one receiver host.

61. The multicast authentication system according to claim 60, wherein the multicast authentication system multicast-forwards the packet of the content stream delivered from the delivery server to the accepted one receiver host within accepted time.

62. The multicast authentication system according to claim 58, wherein
the multicast authentication system further comprises an accounting server provided in the network and charging for an executed service; and
said network interconnection apparatus detects a multicast stream, and transmits detect ion data to said accounting server.
